(19) United States
(12) Patent Application Publication
(10) Pub. No.: US 2012/0175334 A1
(43) Pub. Date: Jul. 12, 2012

(54) OVERHEAD HOIST TRANSPORT SYSTEM AND OPERATING METHOD THEREOF

(76) Inventors: Wei-Chin Chen, New Taipei City (TW); Chih-Wei Tseng, New Taipei City (TW)

(21) Appl. No.: 13/117,103

(22) Filed: May 26, 2011

(30) Foreign Application Priority Data
Jan. 12, 2011 (TW) 100101073

(51) Int. Cl. B66C 13/18; B66C 19/00

(52) U.S. Cl. 212/276; 212/71

(57) ABSTRACT

A method of operating an overhead hoist transport system is provided. A control unit, a plurality of vehicles and a load port are provided. The vehicles are connected to the control unit. At least one vehicle includes an image capture unit. Next, a teaching step is performed by using the image capture unit to pick up an image of the load port. The image is then transferred to the control unit. According to the image of the load port, the control unit determines the position of the load port and drives each vehicle to unload or load at least one article from the load port.

### BACKGROUND OF THE INVENTION

1. Field of the Invention

The present invention is related to an overhead hoist transport system, and more particularly, to an overhead hoist transport system including an image capture unit.

2. Description of the Prior Art

With the sustained progress of the semiconductor industry, in development and design of ultra large scale integrated circuits (ULSI), the size of components scales down to nanometer degree for meeting the design trend of high density integrated circuits. The size of component gets smaller and smaller, and the circuit design gets more complicated. Accordingly, there are hundreds of process steps for fabricating the required integrated circuits, that is, from the beginning to the end of the fabrication process, wafers in the same lot may be repeatedly transported among different tools for processing.

At present, the wafers are transported by the overhead hoist transport system in the fab. The overhead hoist transport system loads the front open united pod (FOUP) full of wafers, and transports the FOUP among different tools along the running rail. When the overhead hoist transport system carries the FOUP to the selected tool, the FOUP is initially placed on the load port adjacent to the tool. After the FOUP is placed on the load port correctly, the wafers are transferred into the tool for performing any of the steps in the semiconductor fabrication process.

However, the position of tools or the load ports may be rearranged due to process renewal, and for this reason, the operator needs to perform a teaching step firstly, so that the overhead hoist transport system can be aware of the new positions of the rearranged objects. As to the conventional teaching step, a teaching unit is manually placed on the rearranged load port, the teaching unit transmits signals to check if the position of load port matches the position of vehicle in the overhead hoist transport system, and the operator adjusts the position of the load port according to the comparison result. Generally, a conventional teaching step requires 5 minutes to 10 minutes to complete. If there are too many rearranged load ports, the total time spent on putting the teaching unit on the rearranged load ports one by one is excessive. Moreover, when the teaching step is proceeding, the vehicles in the related running rails are stopped, consequently, the manufacturing flow is stopped and the productivity is adversely affected. These side effects are unfavorable for the management of the production chain.

### SUMMARY OF THE INVENTION

It is therefore one of the objectives of the present invention to provide an overhead hoist transport system to perform a teaching step without manual operation for improving the reliability of the overhead hoist transport system.

An exemplary embodiment of the present invention provides a method of operating an overhead hoist transport system. At first, a control unit, a plurality of vehicles and a load port are provided. The vehicles are connected to the control unit, and at least one vehicle includes an image capture unit. Then, a teaching step is performed, an image of the load port is picked up by the image capture unit, and the image of the load port is transferred to the control unit. Lastly, a position of the load port is determined according to the image of the load port and each vehicle is driven to unload at least one article to the load port or load at least one article from the load port correctly.

Another exemplary embodiment of the present invention provides a method of operating an overhead hoist transport system. At first, a control unit, a vehicle and a load port are provided. The vehicle is connected to the control unit, and the vehicle includes an image capture unit. Then, an unloading step is performed, and the unloading step includes the following steps: an image of the load port is picked up by the image capture unit, the image of the load port is transferred to the control unit, and a position of the load port is determined according to the image of the load port and the vehicle is driven to unload an article to the load port correctly.

Another exemplary embodiment of the present invention provides a method of operating an overhead hoist transport system. At first, a control unit, a vehicle and a load port are provided. The vehicle is connected to the control unit, the vehicle includes an image capture unit, and an article is on the load port. Then, a loading step is performed, and the loading step includes the following steps: an image of the article is picked up by the image capture unit, the image of the article is transferred to the control unit, and a position of the article is determined according to the image of the article and the vehicle is driven to load the article from the load port correctly.

Another exemplary embodiment of the present invention provides an overhead hoist transport system for carrying an article to a predetermined position. The overhead hoist transport system includes a hoist arm; a driving part connected to the hoist arm, and the driving part drives the hoist arm to extend or draw back along a direction; a platform connected to the hoist arm, and the platform is used for carrying an article; and an image capture unit disposed on an opposite side of the platform with respect to the driving part.

In the present invention, an image capture unit is disposed on the vehicle; consequently, the teaching step can be performed directly according to the position of the load port without additional teaching unit. Additionally, when the vehicle unloads or loads an article, through the image capture unit, the position of load port could be reconfirmed, and further, mishandling during transport can be decreased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 illustrate schematic diagrams of an overhead hoist transport system according to the present invention.

FIG. 3 and FIG. 4 illustrate top views of load port according to the present invention.

FIG. 5 is an operating flow chart of a teaching step in an overhead hoist transport system according to the present invention.

FIG. 6 is an operating flow chart of unloading a wafer box in an overhead hoist transport system according to the present invention.

FIG. 7 illustrates a planar view of a wafer box and stacking holes according to the present invention.

FIG. 8 is an operating flow chart of loading a wafer box in an overhead hoist transport system according to the present invention.

### DETAILED DESCRIPTION

To provide a better understanding of the present invention, preferred embodiments will be made in detail. The preferred embodiments of the present invention are illustrated in the accompanying drawings with numbered elements.

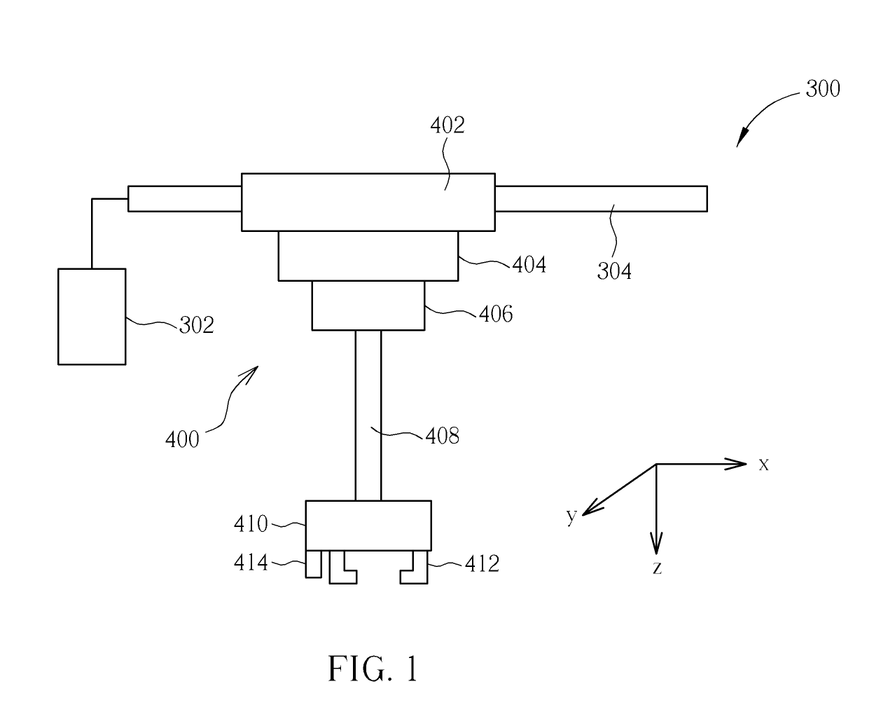

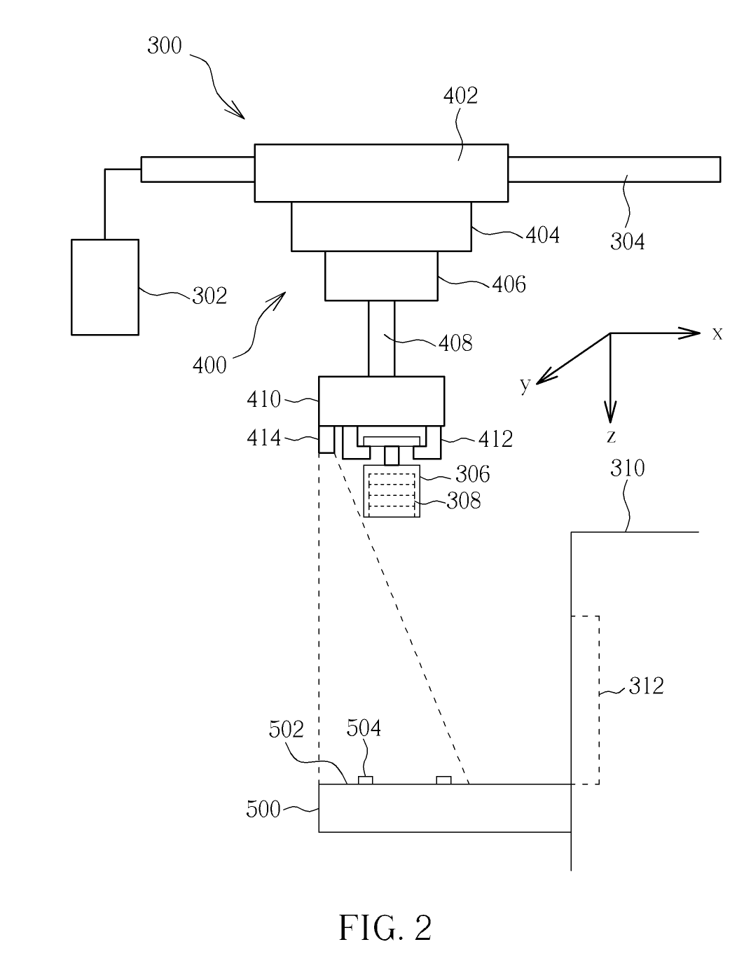

Please refer to FIG. 1 and FIG. 2. FIG. 1 and FIG. 2 illustrate schematic diagrams of an overhead hoist transport system according to the present invention. As shown in FIG. 1, an overhead hoist transport system 300 includes at least one vehicle 400, a control unit 302 and a running rail 304. The control unit 302 such as a computer provides an interface to the operators for managing the overhead hoist transport system 300. At least one vehicle 400 is connected to the control unit 302, and through the command of the control unit 302, the vehicle 400 moves along the running rail 304 and towards a predetermined direction, for example, the x-axis in FIG. 1. In the preferred embodiment of the present invention, the vehicle 400 includes a direct-move driving part 402, a lateral driving part 404, a hoist driving part 406, a hoist arm 408 and a platform 410. The direct-move driving part 402 provides power to the vehicle 400 for moving along the running rail 304 in a predetermined direction, such as the x-axis in FIG. 1. The lateral driving part 404 drives the hoist driving part 406, the hoist arm 408 and the platform 410 disposed below to move along a direction vertical to the running rail 304, such as the y-axis in FIG. 1. The hoist driving part 406 drives the hoist arm 408 to extend or draw back and makes the platform 410 move along a direction vertical to the running rail 304, such as the z-axis in FIG. 1. The platform 410 further includes a loading part 412 for loading an article such as a wafer box. The loading part 412 may be a mechanically driven hook or an electromagnet for adsorbing the magnetic material to fulfill the function of loading. It is appreciated that, the vehicle 400 is not limited to the previous detailed type, but can be any vehicle that is able to move along the running rail 304 and carry articles.

As shown in FIG. 2, the vehicle 400 could transport a wafer box 306 to a predetermined position by moving along the running rail 304. The wafer box 306 may be a front open united pod (FOUP) or a standard mechanical interfaces (SMIFs), and wafers 308 are carried within the wafer box 306. It is appreciated that, the vehicle 400 could transport not only the wafer box 306, but also can transport other articles in an automatic manufacturing process, such as materials or devices in other industries. When the vehicle 400 aims to transport the wafers 308 in the wafer box 306 to a tool 310 for a semiconductor manufacturing process, at first, the vehicle 400 moves and arrives above a load port 500, then, the wafer box 306 is loaded on a load port 500 by the movement of the hoist arm 408, and lastly, the wafer box 306 is transferred into the tool 310 through the door 312.

In the conventional technologies, the position of the load port 500 is validated by a teaching unit and a teaching step to make sure that the vehicle 400 is locating at the load port 500 accurately. However, this manual teaching step would adversely affect the throughput of automatic manufacturing process. One of the features of the present invention is that an image capture unit 414 is disposed in the vehicle 400 for directly detecting the position of the load port 500. The image capture unit 414 is preferably a camera with an image sensor including a charged coupled device (CCD), complementary metal oxide semiconductors (CMOS), or infrared image sensor. The image capture unit 414 is preferably disposed on the side of the platform 410 adjacent to the loading part 412, that is, the opposite side of the platform 410 with respect to the side adjacent to the hoist arm 408, but not limited thereto. In another embodiment, the image capture unit 414 can be disposed at any location, for instance, the image capture unit 414 can also be disposed on the direct-move driving part 402, the lateral driving part 404, or the hoist driving part 406, except for a location that would obstruct the movement of the vehicle 400.

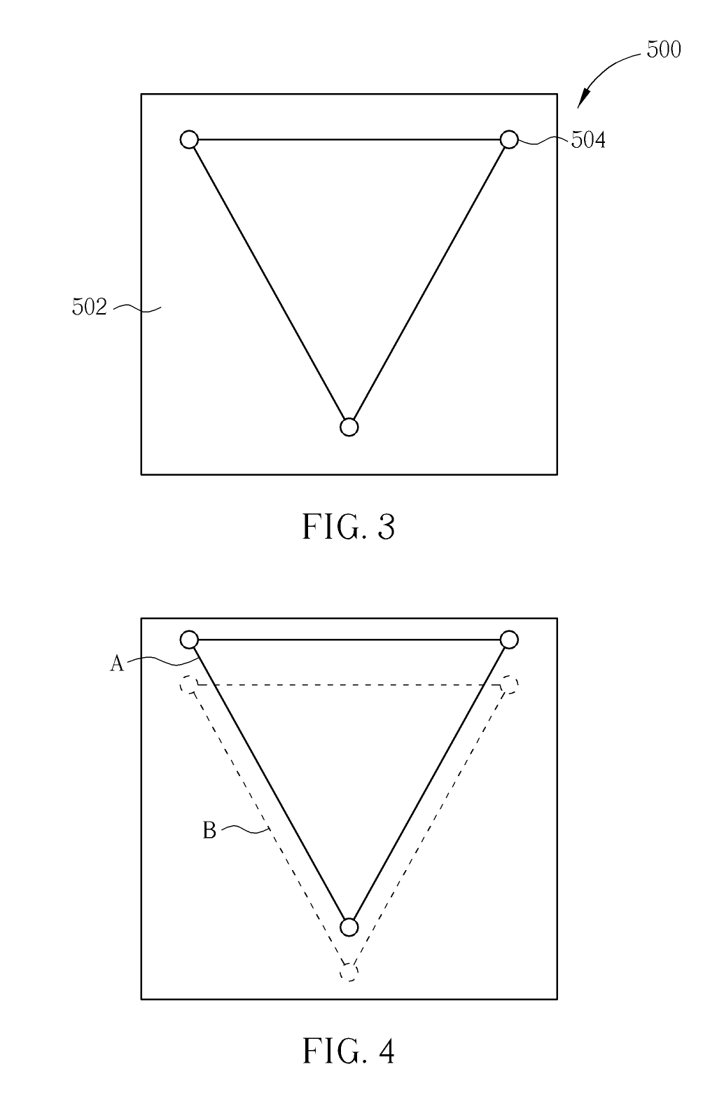

FIG. 3 and FIG. 4 illustrate top views of load port according to the present invention. Please refer to FIG. 3 and refer to FIG. 2 together. As shown in FIG. 3, the load port 500 includes a loading platform 502 and a plurality of kinetic pins 504. The kinetic pins 504 are applied for holding the wafer box 306 and fitting the bottom of the wafer box 306. In the preferred exemplary embodiment of the present invention, the number of the kinetic pins 504 is three, and the kinetic pins 504 are arranged as a regular triangle. One of the features of the present invention is that the image capture unit 414 disposed in the vehicle 400 picks up an image of the kinetic pins 504 for directly determining the position of the load port 500. Please refer to FIG. 4, as shown in FIG. 4, the triangle A surrounded by the solid lines represents the actual position of the kinetic pins 504 in the image picked up by the image capture unit 414, and the triangle B surrounded by the dotted lines represents the assumed position of the kinetic pins 504 when the vehicle 400 is located correspondingly at the kinetic pins 504. In the teaching step, the control unit 302 adjusts the position of the vehicle 400 according to the image of the load port 500 picked up by the image capture unit 414. For example, the control unit 302 adjusts the position of the direct-move driving part 402, the lateral driving part 404, or the hoist driving part 406 for overlapping the triangle A and the triangle B. When the triangle A and the triangle B are accurately overlapped, the vehicle 400 is meant to be in the right position where the positions of the load port 500 and the vehicle 400 are matched. Accordingly, the control unit 302 delivers this calibrated signal to all of the vehicles 400, so that all of the vehicles 400 receive the precise position of the load port 500 for unloading or loading the wafer box 306 accurately.

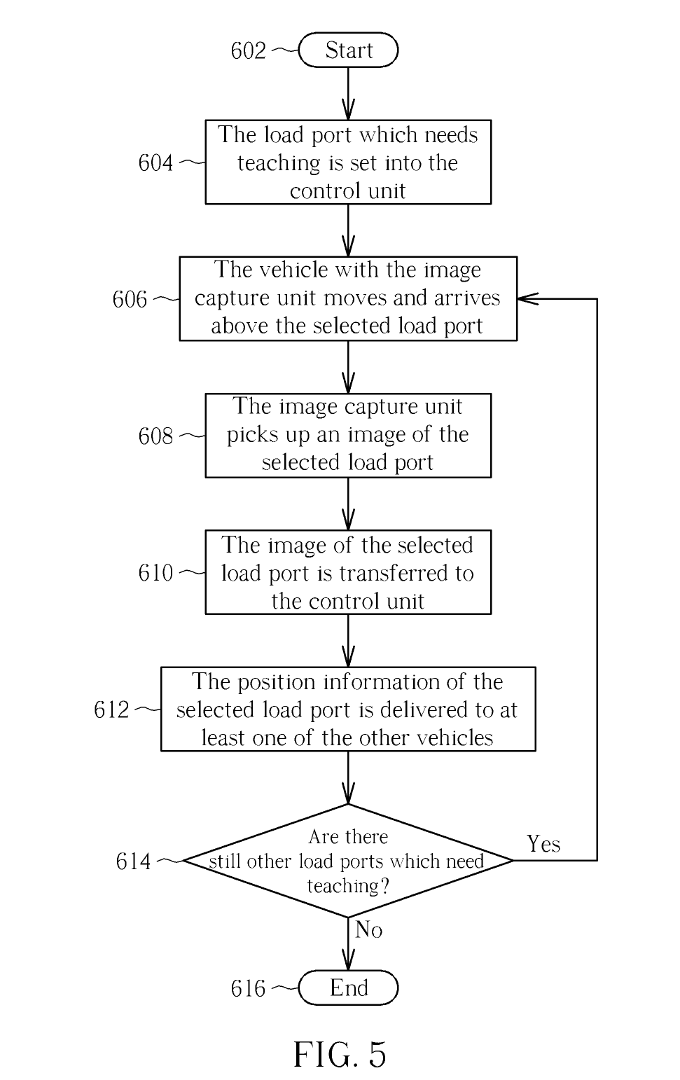

Please refer to FIG. 5. FIG. 5 is an operating flow chart of a teaching step in an overhead hoist transport system according to the present invention. As shown in FIG. 5, firstly, as shown in step 604, the operator sets at least one load port 500 which needs teaching into the control unit 302, then, as shown in step 606, the vehicle 400 with the image capture unit 414 moves and arrives above the selected load port 500. Subsequently, as shown in step 608, the image capture unit 414 picks up an image of the selected load port 500, such as the image of the kinetic pins 504, and as shown in step 610, this image of the selected load port 500 is transferred to the control unit 302. As shown in step 612, a position of the selected load port 500 is determined according to the image of the selected load port 500 and this position information is delivered to at least one of the other vehicles 400. Accordingly, other vehicles 400 could also receive the position information of the load port 500. Furthermore, as shown in step 614, the control unit 302 checks if there are still other load ports 500 which need teaching. If there are still other load ports 500 which need teaching, step 606 to step 612 are repeated, and if there is no other load port 500 which needs teaching, the teaching step is completed as shown in step 616.

As shown in the operating flow chart illustrated in FIG. 5, since at least one vehicle 400 includes the image capture unit 414, the conventional teaching unit becomes unnecessary and the real-time position determination of the load ports 500 is possible. Even if there are a lot of load ports 500 which need teaching, the operator only needs to set up the control unit 302. Afterward, the vehicle 400 moves along the running rail 304 to perform the teaching step for the load ports 500 one by one without additional time spent on manually moving the conventional teaching unit. Furthermore, if the number of vehicle 400 including the image capture unit 414 is more than one, the teaching steps could be performed simultaneously by the vehicles 400 so time can be saved and the manufacturing process can be stabilized without the redundant step of conventional teaching step.

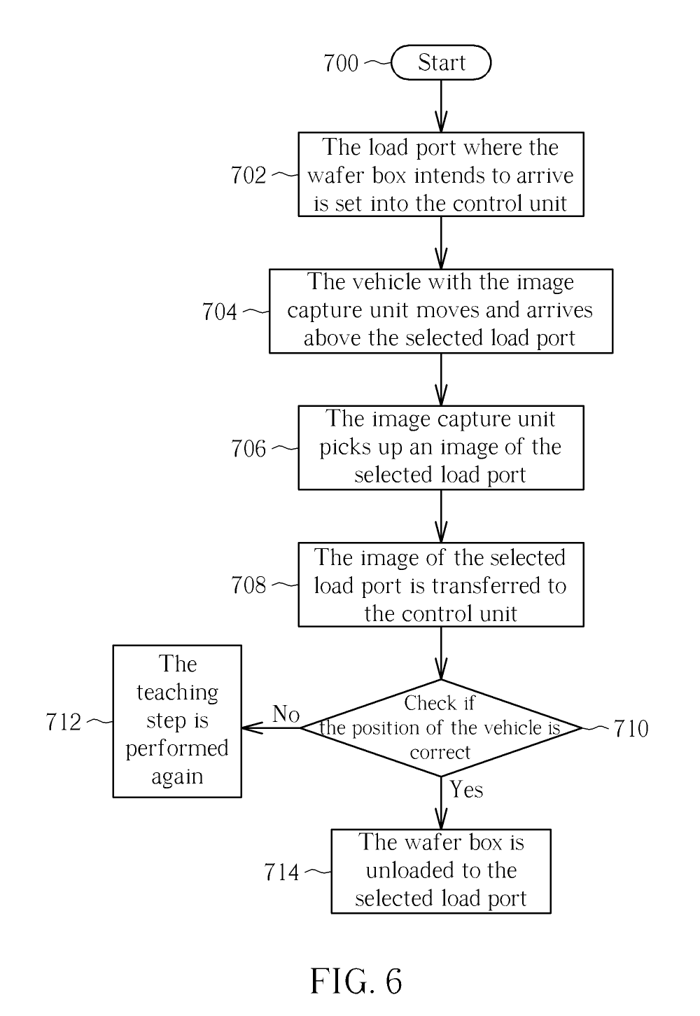

According to another exemplary embodiment of the present invention, if most of the vehicles 400 include the image capture unit 414, these vehicles 400 can not only perform the teaching step, but can also determine the real-time positions of the load ports 500 by using the image capture units 414 for ensuring that the wafer box 306 is unloaded to or loaded from the accurate position of load port 500 every time. Please refer to FIG. 6. FIG. 6 is an operating flow chart of unloading a wafer box in an overhead hoist transport system according to the present invention. At first, as shown in step 702, the operator sets the load port 500 at which the wafer box 306 intends to arrive into the control unit 302, then, as shown in step 704, the vehicle 400 carrying the wafer box 306 moves and arrives above the selected load port 500. Subsequently, as shown in step 706, the image capture unit 414 disposed in the vehicle 400 picks up an image of the selected load port 500 such as an image of the kinetic pins 504, and as shown in step 708, this image of the selected load port 500 is transferred to the control unit 302. As shown in step 710, the control unit 302 could check the position of the vehicle 400 directly or compare the position of the vehicle 400 with the position of the selected load port 500 obtained from the teaching step. Accordingly, if the checking result is correct, as shown in step 714, the wafer box 306 could be unloaded to the selected load port 500; otherwise, the teaching step is performed again as shown in step 712.

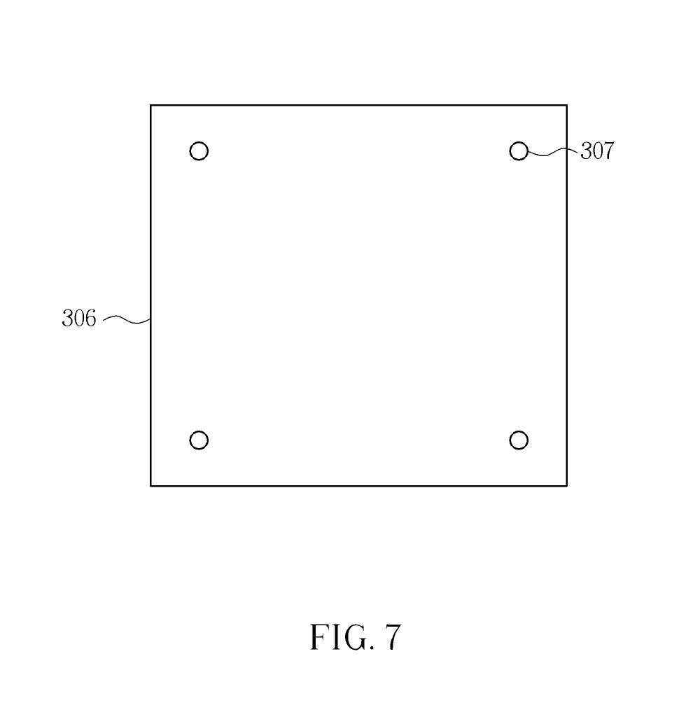

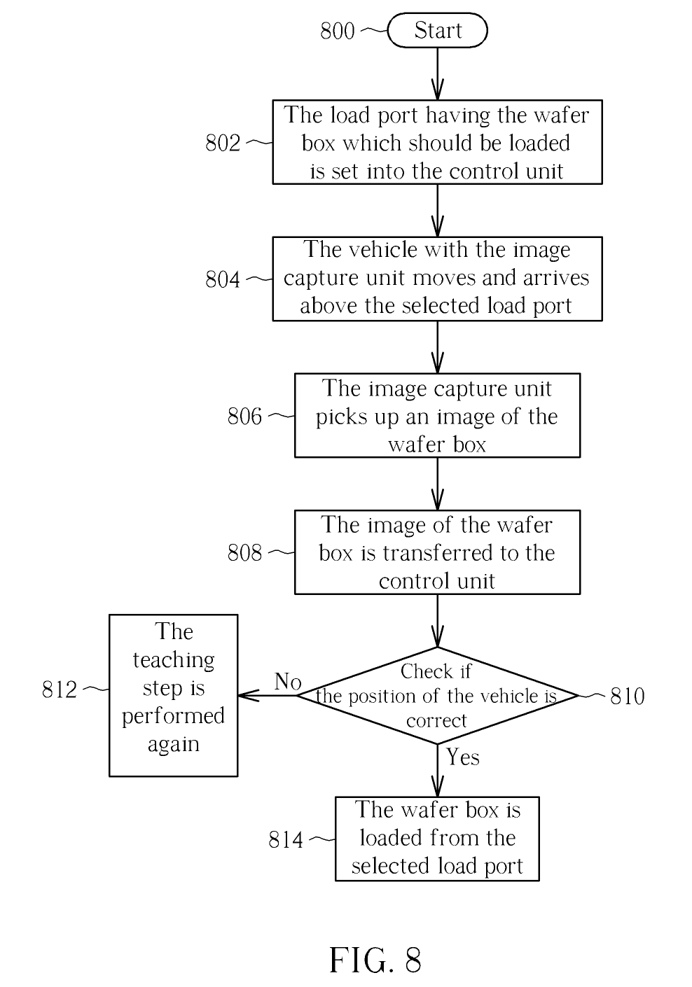

When the vehicle 400 intends to load the wafer box 306 from the load port 500, the wafer box 306 is still on the load port 500 and covers the kinetic pins 504, so that the image capture unit 414 picks up an image of stacking holes on the wafer box 306 instead. Please refer to FIG. 7. FIG. 7 illustrates a planar view of a wafer box and stacking holes according to the present invention. As shown in FIG. 7, a plurality of stacking holes 307 is disposed on a surface of the wafer box 306 for stacking the wafer boxes 306 on each other. In an exemplary embodiment, four stacking holes 307 are disposed and arranged as a square on a wafer box 306, but the number of stacking holes and the arrangement of stacking holes are not limited thereto. Please refer to FIG. 8. FIG. 8 is an operating flow chart of loading a wafer box in an overhead hoist transport system according to the present invention. At first, as shown in step 802, the operator sets the load port 500 having the wafer box 306 which should be loaded into the control unit 302, then, as shown in step 804, the vehicle 400 moves and arrives above the selected load port 500. Subsequently, as shown in step 806, the image capture unit 414 disposed in the vehicle 400 picks up an image of the wafer box 306 such as an image of the stacking holes 307, and as shown in step 808, this image of the wafer box 306 is transferred to the control unit 302. As shown in step 810, the control unit 302 could check the position of the vehicle 400 directly or compare the position of the vehicle 400 with the position information obtained from the teaching step. Accordingly, if the checking result is correct, as shown in step 814, the wafer box 306 could be loaded from the selected load port 500; otherwise, the teaching step is performed again as shown in step 812.

In the present invention, an image capture unit is disposed in the vehicle; consequently, the teaching step can be performed directly according to the position of the load port without additional teaching unit. Additionally, when the vehicle loads or unloads a wafer box, through the image capture unit, the position of load port could be reconfirmed, and further, mishandling during transport can be decreased.

Those skilled in the art will readily observe that numerous modifications and alterations of the device and method may be made while retaining the teachings of the invention.

What is claimed is:

1. A method of operating an overhead hoist transport system, comprising:
providing a control unit, a plurality of vehicles and a load port, wherein the vehicles are connected to the control unit, and at least one vehicle comprises an image capture unit;
performing a teaching step to pick up an image of the load port by the image capture unit;
transferring the image of the load port to the control unit; and
determining a position of the load port according to the image of the load port and driving each vehicle to unload at least one article to the load port or load at least one article from the load port correctly.

2. The method of operating the overhead hoist transport system of claim 1, wherein a teaching unit is not used.

3. The method of operating the overhead hoist transport system of claim 1, wherein the load port comprises:
a loading platform for loading at least one article; and
a plurality of kinetic pins disposed on the loading platform, wherein the image capture unit directly picks up an image of the kinetic pins in the teaching step.

4. The method of operating the overhead hoist transport system of claim 1, wherein the article comprises a front open united pod (FOUP) or a standard mechanical interfaces (SMIFs).

5. A method of operating an overhead hoist transport system, comprising:
providing a control unit, a vehicle and a load port, wherein the vehicle is connected to the control unit, and the vehicle comprises an image capture unit; and
performing an unloading step, the unloading step comprising:
picking up an image of the load port by the image capture unit;
transferring the image of the load port to the control unit; and
determining a position of the load port according to the image of the load port and driving the vehicle to unload an article to the load port correctly.

6. The method of operating the overhead hoist transport system of claim 5, wherein the load port comprises:
a loading platform for loading the article; and
a plurality of kinetic pins disposed on the loading platform, wherein the image capture unit directly picks up an image of the kinetic pins in the unloading step.

7. The method of operating the overhead hoist transport system of claim 5, wherein the article comprises a front open united pod or a standard mechanical interfaces.

8. A method of operating an overhead hoist transport system, comprising:
providing a control unit, a vehicle and a load port, wherein the vehicle is connected to the control unit, the vehicle comprises an image capture unit, and an article is on the load port; and
performing a loading step, the loading step comprising:
picking up an image of the article by the image capture unit;
transferring the image of the article to the control unit; and
determining a position of the article according to the image of the article and driving the vehicle to load the article from the load port correctly.

9. The method of operating the overhead hoist transport system of claim 8, wherein the article comprises a plurality of stacking holes on a surface of the article, and the image capture unit directly picks up an image of the stacking holes in the loading step.

10. The method of operating the overhead hoist transport system of claim 8, wherein the article comprises a front open united pod or a standard mechanical interfaces.

11. An overhead hoist transport system for carrying an article to a predetermined position, and the overhead hoist transport system comprising:
a hoist arm;
a driving part connected to the hoist arm, wherein the driving part drives the hoist arm to extend or draw back along a direction;
a platform connected to the hoist arm, wherein the platform is used for carrying the article; and
an image capture unit disposed on an opposite side of the platform with respect to the driving part.

12. The overhead hoist transport system of claim 11, wherein the image capture unit picks up an image of the predetermined position.

13. The overhead hoist transport system of claim 11, wherein the article comprises a front open united pod or a standard mechanical interfaces.

14. The overhead hoist transport system of claim 11, wherein the predetermined position comprises a load port.
